(19) United States
(12) Patent Application Publication
(10) Pub. No.: US 2021/0217282 A1
(43) Pub. Date: Jul. 15, 2021

(54) GAMING SYSTEM PROVIDING MULTIPLE DRAW GAME

(71) Applicant: IGT GLOBAL SOLUTIONS CORPORATION, Providence, RI (US)

(72) Inventors: Bradford Heathcote, Cumberland, RI (US); Sarah Simpkins, Warwick, RI (US); Aaron Michael Koll, Lincoln, CA (US)

(21) Appl. No.: 16/743,726

(22) Filed: Jan. 15, 2020

(51) Int. Cl. G07F 17/42; G07F 17/32; A63F 3/06

(52) U.S. Cl. CPC G07F 17/42; G07F 17/3258; A63F 3/0655; G07F 17/329

(57) ABSTRACT

A gaming system and a method of operating a gaming system that provides a game with multiple draws such as a lottery game with multiple draws.

### BACKGROUND

Various embodiments of the present disclosure relate to gaming systems and methods of operating gaming systems such as lottery gaming systems that enable the plays of games with multiple draws such as lottery games with multiple draws.

Lottery gaming systems may enable a player to select one or more numbers for a lottery ticket, randomly select winning drawn lottery numbers, and if the winning drawn lottery numbers match the player-selected numbers, provide the player an award associated with the player-selected numbers.

### BRIEF SUMMARY

In various embodiments, the present disclosure relates to a lottery gaming system including a processor and a memory device that stores a plurality of instructions, that when executed by the processor, cause the processor to, for a play of a lottery game determine a player set of symbols from a set of symbols, the set of symbols including a plurality of different symbols, generate a lottery ticket including an indication of the player set of symbols, store data associated with the lottery ticket, and cause the lottery ticket to be provided to the player. The plurality of instructions, when executed by the processor further cause the processor to randomly select a first set of draw symbols from the set of symbols, determine, based on the first set of draw symbols, a set of remaining symbols of the set of symbols, wherein the set of remaining symbols includes the symbols of the set of symbols minus the symbols of first set of draw symbols, and associate a set of awards with the set of remaining symbols. The plurality of instructions, when executed by the processor further cause the processor to randomly select a second set of draw symbols from the set of remaining symbols, and determine any of the awards associated with the player set of symbols based on a comparison of the player set of symbols and the second set of draw symbols, and based on the awards associated with the set of remaining symbols.

In various other embodiments, the present disclosure relates to a gaming system including a processor and a memory device that stores a plurality of instructions, that when executed by the processor, cause the processor to, for a play of a game, determine a player set of symbols from a set of symbols the set of symbols including a plurality of different symbols. The plurality of instructions, when executed by the processor further cause the processor to, at a first draw time, randomly select a first quantity of draw symbols from the set of symbols. The plurality of instructions, when executed by the processor further cause the processor to determine a plurality of remaining symbols from the set of symbols that are not any of the first quantity of draw symbols, associate a plurality of different awards with the determined plurality of remaining symbols, such that each remaining symbol is associated with one of the plurality of different awards, and communicate data to cause a display, by a display device, of the determined plurality of remaining symbols from the set of symbols, and indications of each of the awards associated with the determined plurality of remaining symbols. The plurality of instructions, when executed by the processor further cause the processor to, at a second draw time, randomly select one of the determined plurality of remaining symbols from the set of symbols. The plurality of instructions, when executed by the processor further cause the processor to, responsive to the randomly selected one of the determined plurality of remaining symbols being one of the player set of symbols, determine the award randomly associated with the selected one of the remaining symbols.

In various other embodiments, the present disclosure relates to a method of operating a lottery gaming system. The method includes, for a play of a lottery game, determining, via a processor, a player set of symbols from a set of symbols, the set of symbols including a plurality of different symbols, generating, via the processor, a lottery ticket including an indication of the player set of symbols, storing, via the processor and a memory device, data associated with the lottery ticket, and causing, via the processor, the lottery ticket to be provided to the player. The method further includes randomly selecting, via the processor, a first set of draw symbols from the set of symbols, determining, via the processor, based on the first set of draw symbols, a set of remaining symbols of the set of symbols, wherein the set of remaining symbols includes the symbols of the set of symbols minus the symbols of first set of draw symbols, and associating, via the processor, a set of awards with the set of remaining symbols. The method further includes randomly selecting, via the processor, a second set of draw symbols from the set of remaining symbols, and determining, via the processor, any of the awards associated with the player set of symbols based on a comparison of the player set of symbols and the second set of draw symbols, and based on the awards associated with the set of remaining symbols.

Additional features are described in, and will be apparent from, the following Detailed Description and the figures.

### BRIEF DESCRIPTION OF THE SEVERAL VIEWS OF THE DRAWINGS

FIG. 1 is a flow chart of an example method for operating a lottery gaming system of one embodiment of the present disclosure that provides a game having multiple draws wherein the first draw is employed used to create a set of symbols that will have associated awards.

FIG. 2 is an example lottery play slip of one example embodiment of the lottery gaming system of present disclosure that is employed to enable a player to select a player set of symbols for the play of the game having multiple draws.

FIG. 3 is an example paytable of one example embodiment of the lottery gaming system of present disclosure for a game having multiple draws wherein only certain symbols are associated with awards.

FIG. 4 is an example lottery ticket of one example embodiment of the lottery gaming system of present disclosure for a game having multiple draws that that indicates the player selected symbols for the game.

FIG. 5A is an example first set of drawn lottery numbers of one example embodiment of the lottery gaming system of the present disclosure for a game having multiple draws.

FIG. 5B is an example remaining set of lottery numbers of one example embodiment of the lottery gaming system of the present disclosure for a game having multiple draws.

FIG. 5C is the example first set of drawn lottery numbers of FIG. 5A and an example second set of drawn lottery numbers of one example embodiment of the lottery gaming system of the present disclosure for a game having multiple draws.

FIG. 6 is a schematic diagram of an example lottery gaming system of one embodiment of the present disclosure.

### DETAILED DESCRIPTION

In various embodiments, the present disclosure relates generally to a gaming system and a method of operating a gaming system that provides a game such as a lottery game with multiple draws. In various embodiments, the gaming system and method of operating the gaming system includes a player or automatic selection of a player set of symbols from a set of symbols, a first random draw of a first set of drawn symbols from the set of game symbols, an association of awards with a set of remaining symbols from the set of symbols, a second random draw of a second set of drawn symbols from the set of remaining symbols (from the set of symbols), and a determination of any awards based on a comparison of the player set of symbols and the second set of drawn symbols. Lottery gaming systems, lottery playslips, lottery tickets, and lottery draws are used as non-limiting examples to describe the present disclosure.

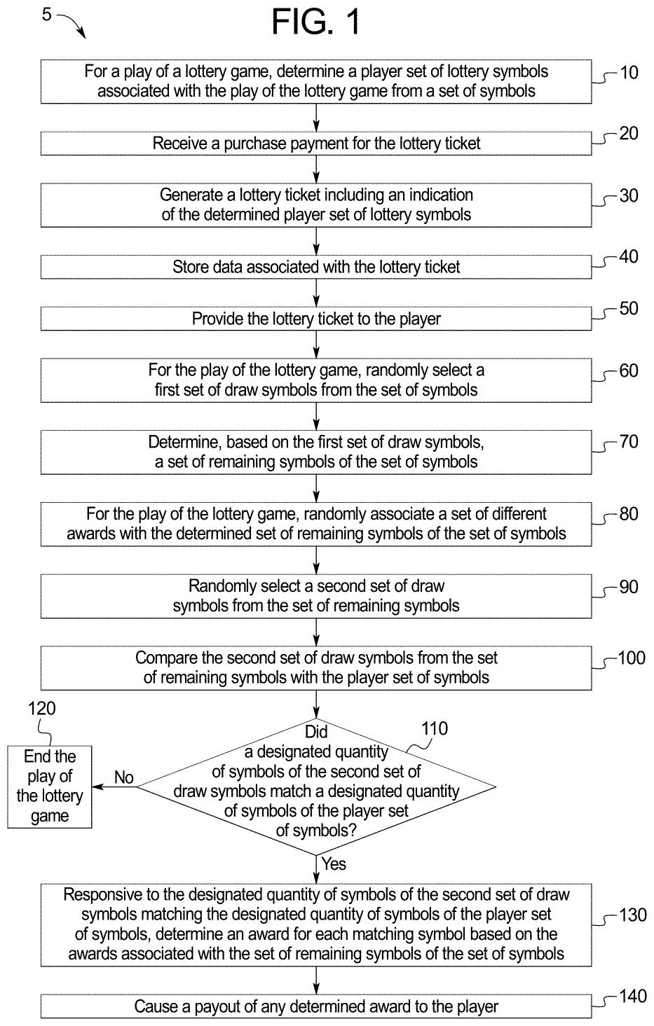

FIG. 1 is a flowchart of an example method or process (indicated by numeral 5) of operating an example lottery gaming system of the present disclosure. In various embodiments, the process 5 is represented by a set of instructions stored in one or more memory devices and executed by one or more processors. Although the process 5 is described with reference to the flowchart shown in FIG. 1, many other processes of performing the acts associated with this illustrated example method may be employed. For example, the order of certain of the illustrated blocks and/or diamonds may be changed, certain of the illustrated blocks and/or diamonds may be optional, or certain of the illustrated blocks and/or diamonds may not be employed.

In the example embodiment illustrated in FIG. 1, the process 5 includes the lottery gaming system configured to: (1) for a play of a lottery game, determine a player set of lottery symbols associated with the play of the lottery game from a set of symbols, as indicated by block 10; (2) receive a purchase payment (that functions as a wager) for the lottery ticket from the player, as indicated by block 20; (3) generate a lottery ticket including an indication of the determined player set of lottery symbols, as indicated by block 30; (4) store data associated with the lottery ticket, as indicated by block 40; and (5) provide the player the lottery ticket (such as a paper copy and/or a virtual copy), as indicated by block 50. The process 5 further includes the lottery gaming system configured to: (6) for the play of the lottery game, randomly select a first set of draw symbols from the set of symbols, as indicated by block 60; (7) determine, based on the first set of draw symbols, a set of remaining symbols of the set of symbols, as indicated by block 70; (8) for the play of the lottery game, randomly associate a set of different awards with the determined set of remaining symbols of the set of symbols, as indicated by block 80; (9) randomly select a second set of draw symbols from the set of remaining symbols, as indicated by block 90; (10) compare the second set of draw symbols from the set of remaining symbols with the player set of symbols, as indicated by block 100; (11) determine if a designated quantity of symbols of the second set of draw symbols match a designated quantity of symbols of the player set of symbols, as indicated in diamond 110; (12) responsive to determining that the designated quantity of symbols of the second set of draw symbols does not match the designated quantity of symbols of the player set of symbols, end the play of the lottery game, as indicated by block 120; (13) on the other hand, as indicated by diamond 110, responsive to the designated quantity of symbols of the second set of draw symbols matching the designated quantity of symbols of the player set of symbols, determine an award for each matching symbol based on the awards associated with the set of remaining symbols of the set of symbols, as indicated in block 130; and (14) cause a payout of any determined award to the player for the lottery ticket, as indicated by block 140.

In various example embodiments, the player set of lottery symbols includes a set of different lottery numbers and the lottery gaming system is configured to: (1) receive from the player a selection of a plurality of different lottery numbers that forms a player set of lottery numbers to wager on for a lottery ticket to be purchased by the player; (2) receive a purchase payment (that functions as the wager) for the lottery ticket from the player; (3) generate a lottery ticket for the player based on the player-selected lottery numbers that form player set of lottery numbers; (4) store data associated with the lottery ticket; (5) provide the player a paper copy and/or a virtual copy of the lottery ticket; (6) at the designated draw time for the play of the lottery game, randomly select a first set of drawn lottery numbers from a set of lottery numbers for the play of the lottery game; (7) based on the first set of drawn lottery numbers, determine a set of remaining lottery numbers of the set of lottery numbers; (8) randomly associate a set of different awards with the determined set of remaining lottery numbers; (9) randomly select a second set of drawn lottery numbers from the set of remaining lottery numbers; (10) compare the second set of drawn lottery numbers from the set of remaining lottery numbers with the player set of lottery numbers; (11) determine whether a designated quantity of the second set of drawn lottery numbers match a designated quantity of the player set of lottery numbers; (12) based on this determination, determine any award(s) for the lottery ticket associated with the matching designated quantity of numbers between the second set of drawn lottery numbers and the player set of lottery numbers; and (13) cause a payout of any such determined award(s) to the player for the lottery ticket. It should thus be appreciated that the symbols employed by the lottery gaming system and method of the present disclosure may be any suitable symbols.

In various other example embodiments, the player set of lottery symbols includes a set of different numbers that are randomly determined by the lottery gaming system (based on an automatic quick pick request from the player), and the lottery gaming system is configured to: (1) receive a request from the player for a random selection, via the lottery gaming system, of a plurality of different lottery numbers that forms a player set of lottery numbers to wager on for a lottery ticket to be purchased by the player; (2) receive a purchase payment (that functions as the wager) for the lottery ticket from the player; (3) generate a lottery ticket for the player based on the gaming system selected numbers that form the player set of lottery numbers; (4) store data associated with the lottery ticket; (5) provide the player a paper copy and/or a virtual copy of the lottery ticket; (6) at the designated draw time for the play of the lottery game, randomly select a first set of drawn lottery numbers from a set of lottery numbers for the play of the lottery game; (7) based on the first set of drawn lottery numbers, determine a set of remaining lottery numbers of the set of lottery numbers; (8) randomly associate a set of different awards with the determined set of remaining lottery numbers; (9) randomly select a second set of drawn lottery numbers from the set of remaining lottery numbers; (10) compare the second set of drawn lottery numbers from the set of remaining lottery numbers with the player set of lottery numbers; determine whether a designated quantity of the second set of drawn lottery numbers match a designated quantity of the player set of lottery numbers; (11) based on this determination, determine any award(s) for the lottery ticket associated with the matching designated quantity of numbers between the second set of drawn lottery numbers and the player set of lottery numbers; and (12) cause a payout of any such determined award(s) to the player for the lottery ticket. It should thus be appreciated that the symbols employed by the lottery gaming system and method of the present disclosure may be any suitable symbols.

In these example embodiments, the gaming system provides one or more awards to a player if the player set of numbers includes or matches a designated quantity (e.g., one number, two numbers, three numbers, up to all of the numbers) of the second set of drawn numbers. In various embodiments, the designated quantity is one such that the second set of drawn lottery numbers includes only one number, and the player wins the award associated with that number if the player set of numbers includes that single number of the second set of drawn numbers. In other words, in these example embodiments, one number of the player set of numbers needs to match one number of the second set of drawn lottery numbers for that lottery ticket to be a winning lottery ticket and for the gaming system to provide the award associated with that single drawn number to that player.

It should be appreciated that the quantity of matches of numbers in the second set to win awards may vary in accordance with the present disclosure. For example, in various embodiment, a plurality of numbers of the player set of numbers (such as three numbers) needs to match the numbers of the second set of drawn numbers for that lottery ticket to be a winning lottery ticket. That is, the gaming system provides the awards to a player if three numbers of the player set of numbers match three numbers of the second set of drawn numbers.

In various example embodiments, the play of the lottery game includes: (1) each player picking (or quick picking) a plurality of different numbers (such as 8 out of 80 numbers of set of numbers from 1 to 80 (inclusive of 1 and 80)) to form the player set of numbers; (2) the gaming system randomly picking a plurality of different numbers (such as 20 out of the 80 numbers of set of numbers 1 to 80 (inclusive of 1 and 80)) to form the first set of drawn numbers; (3) the gaming system determining the set of remaining numbers (such as the 60 non-picked numbers of the set of numbers from 1 to 80 (inclusive of 1 and 80); (4) the gaming system randomly associating a plurality of different awards (such as 4 different awards) with the numbers of the set of remaining numbers (such as the 60 non-picked numbers of the set of numbers from 1 to 80 (inclusive of 1 and 80); (5) the gaming system randomly picking a designated quantity of different numbers (such as 1 out of the 60 numbers of set of remaining numbers to form the second set of drawn numbers; and (6) the gaming system determining if the player set of numbers includes the number(s) in the second set of numbers, and if so, providing the player the awards associated with the numbers in the second set of numbers.

It should be appreciated that after the first set of drawn numbers is determined and after the awards are associated with the numbers of the set of remaining numbers: (1) the player set of numbers may have no numbers that are in the remaining set of numbers and thus have no chance of winning any of the awards; (2) the player set of numbers may one or more numbers that are in the remaining set of numbers and thus have a chance of winning one of the awards; or (3) the player set of numbers may all be in the remaining set of numbers and thus have a better chance of winning one of the award.

It should be appreciated that the different award associated with the numbers of the remaining set of numbers can be any suitable awards. These awards can be static, in static ranges, in changeable ranges, or otherwise changeable. In various embodiments, the changeable awards are progressive awards. In various embodiments, the awards can be static or changeable based on the wager level of the player, or otherwise.

In various example embodiments, the purchase payment for the lottery ticket includes a wager placed on the player set of symbols.

It should be appreciated that the first set of drawn symbols can be part of a separate or additional game such as a play of a keno game. In certain such example embodiments, the wager placed on the player set of symbols is a separate wager from the wager placed on such play of the separate or additional game such as the play of the keno game. In another example embodiment, the wager placed on the player set of symbols includes the wager placed on the play of the separate or additional game such as the keno game (i.e., only one wager required from the player).

In various embodiments, as further described below, the lottery gaming system and method are configured to be provided by a lottery agency (such as a state lottery agency). In various other embodiments, as further described below, the lottery gaming system and method are configured to be operated by a third party that runs the lottery for a lottery agency (such as a state lottery agency).

### Example Embodiment

In one example embodiment of the present disclosure, the lottery gaming system is configured to: (1) enable the player to pick the player set of different lottery numbers from a set of lottery numbers, such as but not limited to numbers 1 through 80 (inclusive of 1 and 80) for the lottery ticket; (2) enable the player to place a wager (e.g., $1, $2, $5, or $10) on the player set of lottery numbers for that lottery ticket (such as 8 of the numbers); (3) randomly select a first set of 20 drawn lottery numbers from the set of 80 lottery numbers; (4) determine a set of 60 remaining lottery numbers of the set of lottery numbers based on a comparison between the set of 80 lottery numbers and the first set of 20 drawn lottery numbers; (5) randomly associate a set of awards (such as 4 different awards) with the determined set of 60 remaining lottery numbers; (6) randomly select a second set of 1 drawn lottery number from the set of 60 remaining lottery numbers; (7) compare the second set of 1 drawn lottery number with the player set of lottery numbers (such as the 8 player numbers); and (8) determine any award to provide to the player based on the award associated with the number of the second set of drawn lottery numbers and whether that number is in the player set of lottery numbers. It should be appreciated that in other embodiments of the present disclosure, the gaming system randomly selects (e.g., quick pick) a player set of lottery numbers from a set of lottery numbers, such as but not limited to numbers 1 through 80 (inclusive of 1 and 80) for the lottery ticket. It should also be appreciated that in other embodiments of the present disclosure, the quantity of numbers, the numbers themselves, the quantity of wager amounts, the wager amounts themselves, the quantity of awards, the awards themselves, may vary in accordance with the present disclosure.

In various embodiments of the present disclosure, the lottery gaming system is configured to enable the player to use one or more paper or virtual playslips to select the player set of lottery numbers, the wager level (e.g., a wager amount on the player set of lottery numbers), and to purchase the lottery ticket.

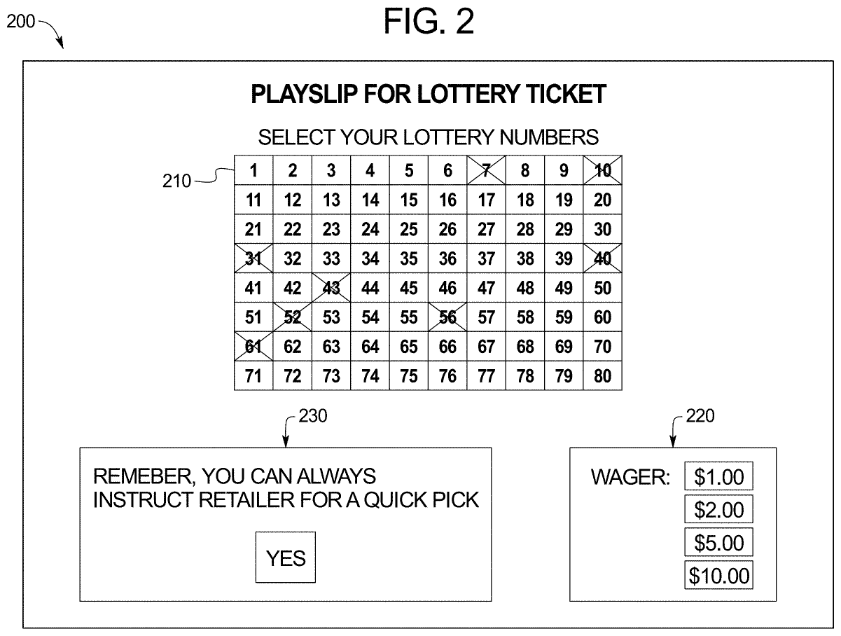

In the example illustrated embodiment shown in FIG. 2, the lottery gaming system is configured to enable the player to use a single paper or virtual playslip to select the player selectable numbers of the player set of lottery numbers, the wager level (e.g., a wager amount on the player set of lottery numbers), and to purchase the lottery ticket. FIG. 2 illustrates an example playslip 200. This playslip 200 includes: (1) a symbol (or number) selection portion 210; (2) a wager indication portion 220; and (3) a quick pick instruction portion 230.

In various example embodiments, the lottery gaming system enables the player to utilize the quick pick instruction portion 230 of the payslip 200 to request the lottery gaming system to randomly select the symbols (or numbers) of the player set of lottery numbers for the play of the lottery game. That is, instead of the player selecting lottery numbers to form the player set of lottery numbers, the player can instruct the lottery gaming system to randomly select lottery numbers to form the player set of lottery numbers. It should be appreciated that other embodiments of the playslip may include additional or alternative portions and player options and the playslip can be arranged in any suitable manner in accordance with the present disclosure.

In this example illustrated embodiment shown in FIG. 2, the number selection portion 210 of the playslip 200 includes a set of eighty different lottery numbers from which the player can select (or instruct the lottery gaming system to randomly select) one or more numbers. Particularly, the number selection portion 210 includes a separate individual selectable area for each lottery number of the set of lottery numbers 1 through 80 (inclusive of 1 and 80). In this illustrated example, each area includes a respective different number surrounded by a rectangular boarder. It should be appreciated that while the number selection portion 210 includes a set of eighty different lottery numbers, any suitable arrangement of numbers (or symbols) may be possible.

In this example illustrated embodiment, the player has selected a set of eight lottery numbers (and particularly, the numbers “7,” “10,” “31,” “40,” “43,” “52,” “56,” and “61”) on the number selection portion 210 of the playslip 200 for the player set of lottery numbers. These player-selected numbers (that form the player set of lottery numbers) are marked with “X”s over the respective numbers in this example. It should be appreciated that the player-selected numbers may be marked in any other suitable manner. It should also be appreciated that the player can alternatively instruct the lottery gaming system to randomly select the set of lottery numbers that form the player set of lottery numbers for the play of the lottery game.

In this example illustrated embodiment, the wager indication portion 220 of the playslip 200 includes a wager entry portion that the player utilizes for placing a wager on the play of the lottery game. For example, the player may indicate a wager level of $1, $2, $5, $10, or other such suitable wager on the play of the lottery game. In this example embodiment, the player may indicate a desired wager amount placed on the player set of lottery numbers selected in the number selection portion 210, of playslip 200. In this example embodiment, the player indicated wager amount of $1.00 (as indicated by the “X”) is applied to the player-selected set of lottery numbers that form the player set of lottery numbers. As shown in FIG. 2, in this example illustrated embodiment, the player has indicated a wager of $1 placed on the player set of lottery numbers for the play of the lottery game. This player indicated wager amount is indicated on the playslip 200 with “$1.00” marked in the wager indication portion 220.

In this example illustrated embodiment of FIG. 2, the quick pick instruction portion 230 of the playslip 200 includes a message “REMEMBER, YOU CAN ALWAYS INSTRUCT RETAILER FOR A QUICK PICK,” that reminds the player that they can have the lottery gaming system randomly select the set of lottery numbers that form the player set of lottery numbers for the play of the lottery game. In this example embodiment, the player has selected certain numbers in the number selection portion 210 of the playslip 200. As such, the player selects their own desired set of lottery numbers that form the player set of lottery numbers for the play of the lottery game. In other example embodiments that are not shown, if the player would like the lottery gaming system to randomly pick the set of lottery numbers that form the player set of lottery numbers for the play of the lottery game, the player does not select any numbers in the number selection portion 210, and instructs the lottery gaming system to randomly select the set of lottery numbers that form the player set of lottery numbers for the play of the lottery game (such as by marking the illustrated example quick pick YES box).

After making all of the needed player selections on the playslip 200, the lottery gaming system enables the player to purchase a lottery ticket through the lottery gaming system. In various embodiments of the lottery gaming system, the playslip is paper and the player may purchase the lottery ticket via the paper playslip. In various other embodiments of the lottery gaming system, the playslip is virtual and the player may purchase the lottery ticket via the virtual playslip. In various other embodiments, the lottery gaming system is configured to accommodate both paper and virtual playslips.

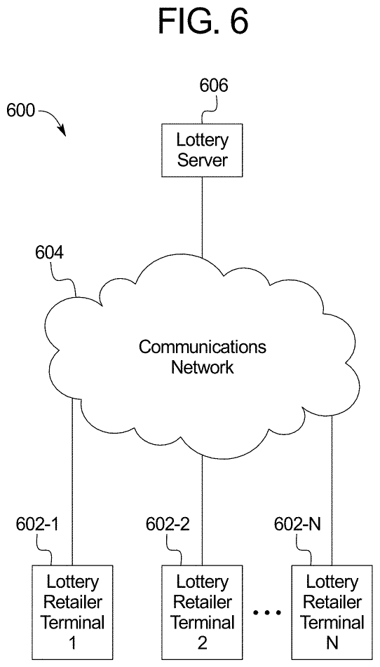

In various embodiments of the lottery gaming system, the player may purchase the lottery ticket via any suitable manner such as, but not limited to, one of the following: (1) a dedicated lottery kiosk (e.g., a lottery kiosk) configured to communicate over a data network (such as the Internet) to a lottery server (such as a lottery server 606 described below in connection with FIG. 6); (2) a retailer-operated lottery terminal configured to communicate over a data network (such as the Internet) to a lottery server (such as a lottery server 606 described below in connection with FIG. 6); (3) a personal computer configured to communicate over a data network (such as the Internet) to a lottery server (such as a lottery server 606 described below in connection with FIG. 6); and/or (4) a personal mobile device (such as a cellular telephone, tablet, a smart phone, or PDA) configured to communicate over a data network (such as a wireless or cellular data network) to a lottery server (such as a lottery server 606 described below in connection with FIG. 6).

In one such example embodiment, the lottery gaming system enables a player to use a paper playslip to purchase a lottery ticket at a retail location having a lottery terminal configured to receive the playslip and print the lottery ticket at the time of purchase in a conventional manner. In such lottery gaming systems, the retail operator typically receives the purchase price for the lottery ticket from the player in a conventional manner.

In another such example embodiment, the lottery gaming system enables a player to use a virtual playslip to purchase a lottery ticket through a retail lottery kiosk configured to display the playslip (as further described below), receive the player selections using the displayed playslip (as further described below), receive the wager from the player, and print the lottery ticket at the time of purchase. This example lottery kiosk may include an integral printer device and/or be in communication with a printer device for providing a printed lottery ticket to the player.

In another such example embodiment, the lottery gaming system enables a player to use a virtual playslip to purchase a lottery ticket electronically using a personal mobile device such as the player's mobile telephone. In one such embodiment, the lottery gaming system receives from this device the player selections and the wager from the player, and sends the player a virtual lottery ticket (which in certain instances can be printed by the player using a suitable personal printing device). Thus, it should be appreciated that in various example embodiments, the player may purchase a lottery ticket with a personal mobile device and, thus, may not be provided with a physical (i.e., paper) lottery ticket. Instead, an electronic (or virtual) version of the lottery ticket is provided to the player via, for example, an electronic mail to an email account associated with the player.

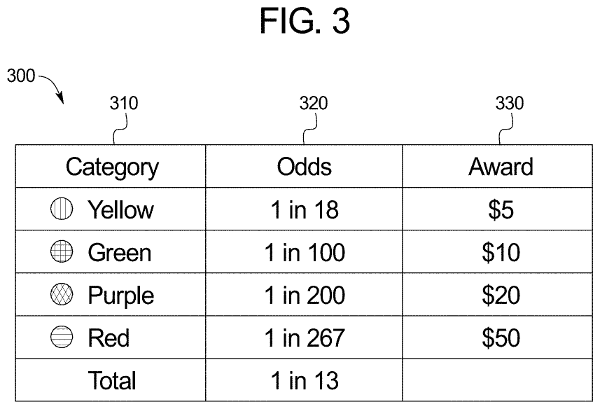

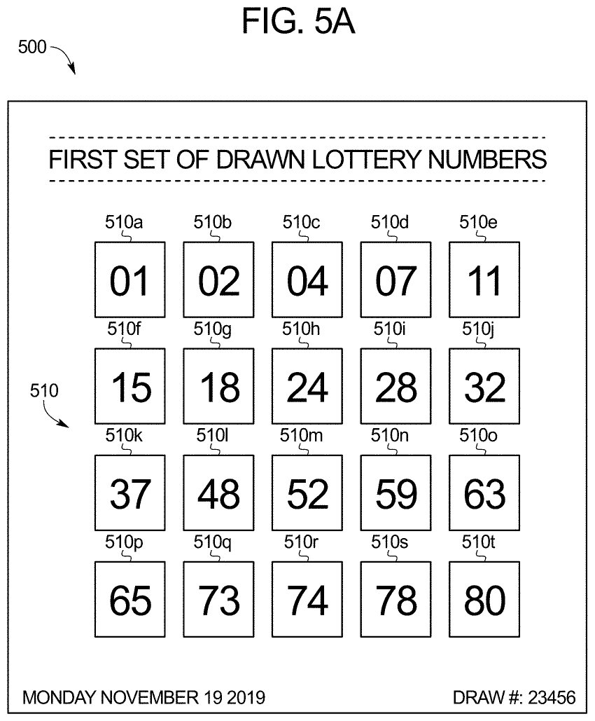

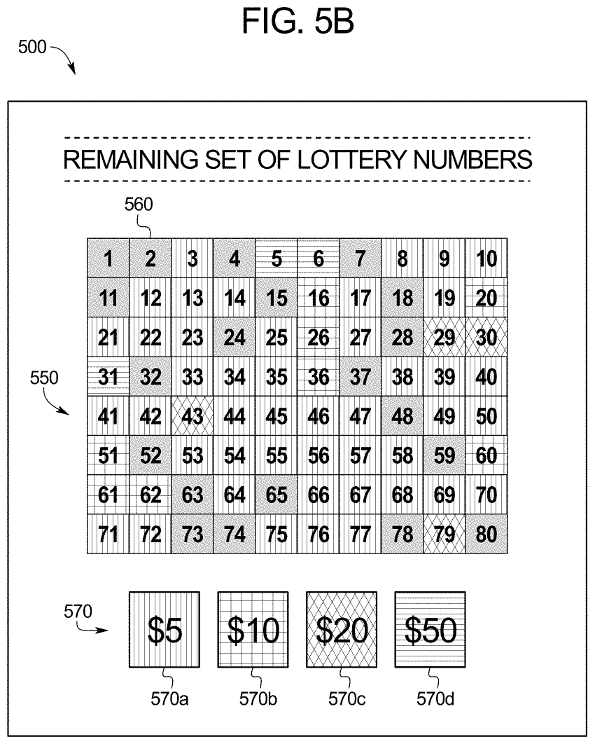

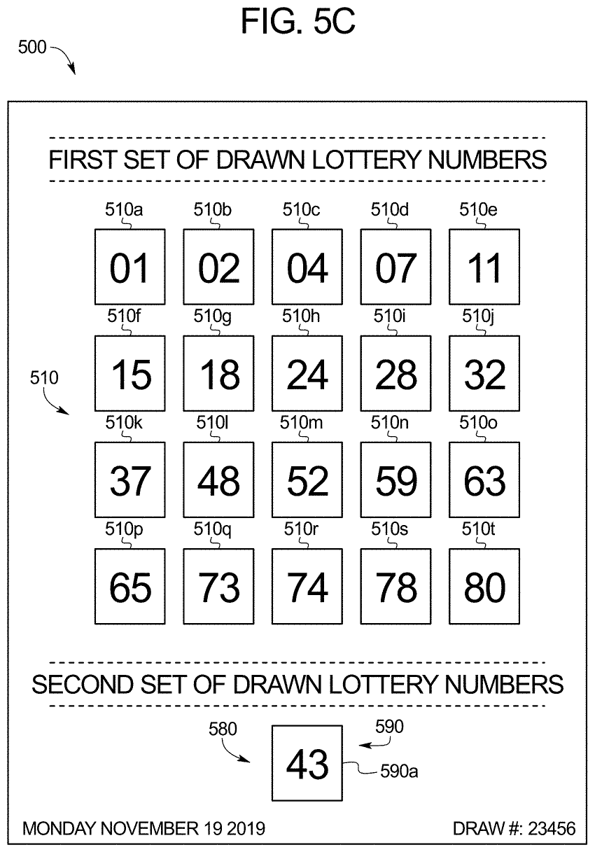

FIG. 3 illustrates one example paytable 300 associated with and respectively corresponding to a determined set of remaining lottery numbers (such as the determined set of remaining lottery numbers 550 of FIG. 5B) the player set of numbers shown in the number selection portion 210 of FIG. 2. In this example illustrated embodiment, the lottery game paytable 300 includes: (1) an award category identifier column 310; (2) an award odds column 320; and (3) an award column 330.

In this example illustrated embodiment, the award category identifier column 310 includes a plurality of different award category identifiers (e.g., Yellow, Green, Purple, and Red). In this example illustrated embodiment, each number of a determined set of remaining lottery numbers (such as the determined set of remaining lottery numbers 550 of FIG. 5B) is associated with one of the plurality of different award category identifiers. In this example illustrated embodiment, each award category identifier is associated with an award odds displayed in the respective awards odds column 320 and an award displayed in the respective award column 330.

In this example illustrated embodiment, the paytable 300 includes: (1) a “Yellow” award category identifier of the award category identifier column 310 having a “1 in 18” award odds of the award odds column 320 and a “$5” award in the award column 330; (2) a “Green” awards category identifier of the award category identifier column 310 having a “1 in 100” award odds of the award odds column 320 and a “$10” award in the award column 330; (3) a “Purple” awards category identifier of the award category identifier column 310 having a “1 in 200” award odds of the award odds column 320 and a “$20” award in the award column 330; and (4) a “Red” awards category identifier of the award category identifier column 310 having a “1 in 267” award odds of the award odds column 320 and a “$50” award in the award column 330. It should be appreciated that other embodiments of the paytable may include additional or alternative portions and the paytable can be arranged in any suitable manner in accordance with the present disclosure. It should also be appreciated that while the paytable includes four different award category identifiers, any other suitable number of different award category identifiers associated with award odds and awards are possible in accordance with the present disclosure.

Thus, in this example illustrated embodiment, each of the award category identifiers of column 310 is respectively associated with a determined award odds of column 320 and respectively associated with a determined award of column 330. As such, the award category identifiers displayed in column 310 are associated with different award odds and different awards. It should be appreciated that the odds for each category are based on how many of the 60 numbers of the set of remaining numbers are associated with each award category and thus each award. This enables the operator of the lottery game to easily change the awards and odds based upon how many different awards are employed and how many of each of those awards are associated with the remaining numbers of the set of remaining lottery numbers.

In various example embodiments, the lottery system resets the awards associated with the lottery for each play of the lottery game.

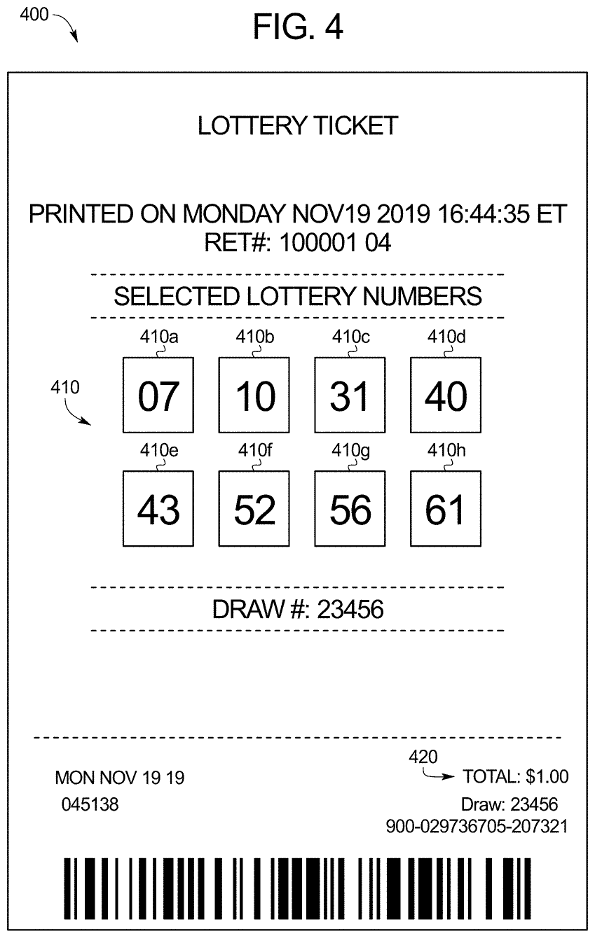

FIG. 4 illustrates an example lottery ticket 400 that may be issued to a player based on the selected numbers of the player set of lottery numbers, and a wager amount for the play of the lottery game. In this example embodiment, the lottery ticket 400 includes a player set of symbols (or numbers) portion 410, and a total wager amount portion 420. It should be appreciated that in various embodiments, the lottery ticket may display or include additional or alternative information, such as lottery game draw number, a lottery game number, a player identifier, a serial number, and/or any other relevant information. It should also be appreciated that the lottery ticket provided by the lottery gaming system of the present disclosure may be alternatively configured.

In this example illustrated embodiment, the player set of symbols (or numbers) portion 410 of the lottery ticket 400 separately and individually includes and indicates each of the lottery numbers that form the player set of lottery numbers. In this example embodiment, each lottery number of the player set of lottery numbers includes a lottery number identifier, such as number identifiers 410a, 410b, 410c, 410d, 410e, 410f, 410g, and 410h. The respective lottery number identifiers correspond to the respective lottery number of the player set of lottery numbers.

In this example illustrated embodiment, the lottery numbers that form the player set of lottery numbers of the lottery ticket 400 include: (a) the number “07” of lottery number identifier 410a, (b) the number “10” of lottery number identifier 410b, (c) the number “31” of lottery number identifier 410c, (d) the number “40” of lottery number identifier 410d, (e) the number “43” of lottery number identifier 410e, (f) the number “52” of lottery number identifier 410f, (g) the number “56” of lottery number identifier 410g, and (h) the number “61” of lottery number identifier 410h.

In this example, the lottery ticket 400 may be determined as a winning lottery ticket for the play of the lottery game player if any one of the lottery numbers of the player set of lottery numbers 410a to 410h match the one lottery number of the second set of drawn lottery numbers from the set of remaining lottery numbers (such as the remaining set of lottery numbers 550 of FIG. 5B).

In this example embodiment, for each lottery ticket purchased, the lottery gaming system creates a data record corresponding to that lottery ticket. For example, when a lottery terminal is used to purchase a lottery ticket, the lottery gaming system creates a data record including suitable information such as but not limited to: (1) a timestamp (date and/or time) associated with when the lottery ticket was purchased; (2) the selected lottery numbers of the player set of lottery numbers; (3) the player-selected wager amount or wager level associated with the player set of lottery numbers; (5) the lottery game draw number and/or lottery game number; (5) the lottery ticket identification number; and (6) any other suitable information.

In various example embodiments, this data record is created by the lottery terminal and sent by the lottery terminal to the lottery server (such as described below in connection with the lottery server 606 of FIG. 6). It should be appreciated that the lottery ticket data record can be otherwise suitably created in accordance with the present disclosure.

FIGS. 5A, 5B, and 5C illustrate an example first set of lottery drawn lottery numbers, an example determined set of remaining lottery numbers, and an example second set of drawn lottery number for the play of the lottery game. FIG. 5A illustrates an example first set of drawn lottery numbers 500 that are drawn for a play of a lottery game. In this example illustrated embodiment, the first set of drawn lottery numbers 500 includes a drawn symbols (or numbers) portion 510 that displays the first set of drawn lottery numbers for the play of the lottery game. It should be appreciated that in various embodiments, the first set of drawn lottery numbers 500 may display or include additional or alternative information, such as a date/time of drawing the first set of drawn lottery numbers, a lottery draw number associated with the first set of drawn lottery numbers, a lottery game number associated with the first set of drawn lottery numbers, and/or any other relevant information. It should also be appreciated that the first set of drawn lottery numbers provided by the lottery gaming system of the present disclosure may be alternatively configured.

In this example illustrated embodiment, the drawn numbers portion 510 of the lottery ticket 500 separately and individually includes and indicates each of the drawn lottery numbers that form the first set of drawn lottery numbers 500. In this example embodiment, each lottery number of the first set of drawn lottery numbers 500 displayed in the drawn numbers portion 510 includes a drawn lottery number identifier, such as number identifiers 510a, 510b, 510c, 510d, 510e, 510f, 510g, 510h, 510i, 510j, 510k, 510l, 510m, 510n, 510o, 510p, 510q, 510r, 510s, and 510t. The respective drawn lottery number identifiers correspond to the respective lottery number of the first set of drawn lottery numbers 500.

In this example illustrated embodiment, the lottery gaming system randomly selects a set of twenty drawn lottery numbers including: (a) the number “1” of drawn lottery number identifier 510a; (b) the number “2” of drawn lottery number identifier 510b, (c) the number “4” of drawn lottery number identifier 510c; (d) the number “7” of drawn lottery number identifier 510d; (e) the number “11” of drawn lottery number identifier 510e, (f) the number “15” of drawn lottery number identifier 510f, (g) the number “18” of drawn lottery number identifier 510g, (h) the number “24” of drawn lottery number identifier 510h; (i) the number “28” of drawn lottery number identifier 510i, (j) the number “32” of drawn lottery number identifier 510j; (k) the number “37” of drawn lottery number identifier 510k; (1) the number “48” of drawn lottery number identifier 510l; (m) the number “52” of drawn lottery number identifier 510m; (n) the number “59” of drawn lottery number identifier 510n; (o) the number “63” of drawn lottery number identifier 5100; (p) the number “65” of drawn lottery number identifier 510p, (q) the number “73” of drawn lottery number identifier 510q, (r) the number “74” of drawn lottery number identifier 510r; (s) the number “78” of drawn lottery number identifier 510s, and (t) the number “80” of drawn lottery number identifier 510t

In this example embodiment, at the designated times for each lottery game or draw, the lottery gaming system randomly selects the first set of drawn lottery numbers 500 from the set of lottery numbers, such as but not limited to numbers 1 through 80 (inclusive of 1 and 80). In this example embodiment, the random selection of the first set of drawn lottery numbers 500 is based on equal odds for selecting each number. As such, each of the possible lottery numbers from the set of lottery numbers has a chance of being selected for the first set of drawn lottery numbers. For example, the eighty possible lottery numbers of the number selection portion 210 of FIG. 2 each has a 1/80 chance of being selected.

In this example illustrated embodiment, the lottery gaming system randomly selects twenty lottery numbers from the set of lottery numbers (such as twenty of the numbers 1 through 80 (inclusive of 1 and 80). The gaming system applies the first set of drawn lottery numbers 500 to the set of lottery numbers (such as numbers 1 through 80, inclusive of 1 and 80) to determine the set of remaining lottery numbers for the play of the lottery game. In this illustrated example embodiment, the remaining set of lottery numbers includes the lottery numbers of the set of lottery numbers minus the lottery numbers of the first set of drawn lottery numbers 500. That is, the gaming system determines the set of remaining lottery numbers based on which lottery numbers of the first set of drawn lottery numbers 500 do not hit or match the lottery numbers of the set of lottery numbers. As such, any lottery number not included in the first set of drawn lottery numbers 500 is included in the determined set of remaining lottery numbers. In this example illustrated embodiment, the gaming system marks or otherwise indicates the numbers of the first set of drawn lottery numbers 500 that are eliminated from the set of lottery numbers to form the remaining set of lottery numbers.

It should be appreciated that in various embodiments, the first set of drawn lottery numbers 500 may display or include additional or alternative information, such as a date/time of drawing the first set of drawn lottery numbers, a lottery draw number associated with the first set of drawn lottery numbers, a lottery game number associated with the first set of drawn lottery numbers, and/or any other relevant information. It should also be appreciated that the first set of drawn lottery numbers provided by the lottery gaming system of the present disclosure may be alternatively configured.

As mentioned above, in various example embodiments, the first set of drawn lottery numbers are associated with the play of a game in addition to the play of the lottery game, such as but not limited to the play of a keno game. In such example embodiments, the lottery numbers of the set of lottery numbers are keno game numbers. In such embodiments, the random selection of the lottery numbers of the first set of drawn lottery numbers is part of a play of a keno game that is in addition to the play of the lottery game. In such embodiments, the player set of lottery numbers is part of the play of the keno game that is in addition to the play of the lottery game.

FIG. 5B illustrates an example set of remaining lottery numbers 550 determined from the set of eighty lottery numbers for the play of a lottery game. In this example illustrated embodiment, the display of the set of remaining lottery numbers 550 includes: (1) a remaining lottery number portion 560 that displays the set of remaining lottery numbers 550 for the play of the lottery game; and (2) an award indication portion 570 that defines one or more awards associated with each of the numbers of the set of remaining lottery numbers 550. In this example illustrated embodiment, the gaming system determines the set of remaining lottery numbers 550 based on a comparison between the set of eighty lottery numbers (such as numbers 1 through 80, inclusive of 1 and 80 displayed in the number selection portion 210 of FIG. 2) and the lottery numbers of the first set of drawn numbers (such as the first set of drawn lottery numbers 500 of FIG. 5A). More specifically, the remaining set of lottery numbers 550 includes the lottery numbers of the set of lottery numbers minus the lottery numbers of the first set of drawn lottery numbers 500.

In this example illustrated embodiment, the gaming system marks or otherwise removes each of the lottery numbers of the first set of drawn lottery numbers 500 (and particularly lottery numbers “1,” “2,” “4,” “7,” “11,” “15,” “18,” “24,” “28,” “32,” “37,” “48,” “52,” “59,” “63,” “65,” “73,” “74,” “78,” and “80”) from the set of lottery numbers to indicate the lottery numbers of the remaining set of lottery numbers 550. In this example illustrated embodiment, the remaining lottery number portion 560 shades or greys out each lottery number of the first set of drawn numbers 500 is from the display of the set of eighty lottery numbers. As such, the gaming system determines the set of remaining lottery numbers based on which lottery numbers are not greyed out from the set of lottery numbers. That is, the set of remaining lottery numbers include any lottery numbers from the set of lottery numbers that are not included in the first set of drawn numbers 500. It should be appreciated that the second set of drawn numbers can be from all of the numbers or just from the remaining numbers in different embodiments. In various such embodiments, one or more or all of the players may have a chance of matching the second set of drawn numbers or not matching the second set of drawn numbers (which can result in no winning players).

In various example embodiments, the lottery gaming system determines the remaining set of lottery numbers after the player places a wager on the player set of lottery numbers of the lottery ticket. As such, when the player places a wager on their player set of lottery numbers, that player has no knowledge or indication of how many lottery numbers of the player set of lottery numbers will be included in the remaining set of lottery numbers for the play of the lottery game.

In one example, all of the lottery numbers of the player set of lottery numbers are included in the first set of drawn lottery numbers. Thus, none of lottery numbers of the player set of lottery numbers are included the remaining set of lottery numbers. In such example, the player is eliminated from the play of lottery game because the player set of lottery numbers does not include any lottery numbers of the remaining set of lottery numbers.

In another example, a portion of the lottery numbers of the player set of lottery numbers (such as four lottery numbers) are included in the first set of drawn lottery numbers. Thus, some of the player set of lottery numbers are included in the remaining set of lottery numbers. In this example, the player continues with the play of the lottery game because a portion of the lottery numbers of the player set of lottery numbers (such as four lottery numbers) are included in the remaining set of lottery numbers.

In another example, none of the lottery numbers of the lottery numbers of the player set of lottery numbers are included in the first set of drawn lottery numbers. Thus, all of the lottery numbers of the player set of lottery numbers are included in the remaining set of lottery numbers. In this example, the player continues with the play of the lottery game because all of the lottery numbers of the player set of lottery numbers (such as eight lottery numbers) are included in the remaining set of lottery numbers.

In this example illustrated embodiment, the award indication portion 570 indicates a plurality of different awards associated with each lottery number of the remaining set of lottery numbers 550, the award indication portion 570 includes: (a) a “$5” award indicator 570a; (b) a “$10” award indicator 570b; (c) a “$20” award indicator 570c; and (d) a “$50” award indicator 570d. In this example illustrated embodiment, the plurality of different award indicators 570a, 570b, 570c, and 570d are each associated with an award identifier (such as the different award category identifiers Yellow, Green, Purple, and Red of award category identifier column 310 of FIG. 3) to identify and indicate the different awards associated with the set of remaining lottery numbers 550. It should be appreciated that while the award indicators are associated with different colors to identify the different awards, any other suitable award identifiers can be utilized to identify the different awards in accordance with the present disclosure.

In this example illustrated embodiment, after determination of the set of remaining lottery numbers 550, the gaming system then randomly associates each lottery number of the set of remaining lottery numbers 550 with one of the plurality of different awards associated with award indicators 570a, 570b, 570c and 570d. In various example embodiments, the gaming system randomly marks each lottery number of the set of remaining lottery numbers 550 with one of the plurality of different award indicators 570a, 570b, 570c, and 570d according to the different odds and the different award amounts defined in paytable 300. These different award indicators mark the respective numbers with a color (such as Yellow, Green, Purple and Red) to identify and indicate the different awards associated with the set of remaining lottery numbers 550. It should be appreciated that the set of remaining lottery numbers 550 may be marked in any other suitable manner.

In the illustrated example embodiment, according to paytable 300, a player of the lottery game has the following odds and different award amounts: (1) 1 in 18 odds of winning a $5 award associated with award indicator 570a; (2) 1 in 100 odds of winning a $10 award associated with award indicator 570b; (3) 1 in 200 odds of winning a $20 award associated with award indicator 570c; and (4) 1 in 267 odds of winning a $50 award associated with award indicator 570d.

In this example illustrated embodiment, the gaming system displays which different award (and different award indicator 570a, 570b, 570c and 570d) that each lottery number of the set of remaining lottery numbers 550 is associated with. In this example illustrated embodiment, the gaming system marks or otherwise indicates each lottery number of the set of remaining lottery numbers 550 including: (1) numbers “3” “8,” “9” “10” “12” “13” “14” “17” “19” “21,” “22,” “23,” “25,” “27,” “33” “34,” “35,” “38,” “39” “40,” “41,” “42,” “44” “45” “46” “47,” “49” “50,” “53” “54,” “55” “56,” “57” “58,” “64,” “66,” “67,” “68,” “69,” “70,” “71,” “72,” “75,” “76,” and “77” marked with award indicator 570a and associated with a $5 award; (2) numbers “16,” “20,” “26,” “36,” “51,” “60,” “61,” and “62,” marked with award indicator 570b and associated with a $10 award; (c) numbers “29,” “30,” “43,” and “79” marked with award indicator 570c and associated with a $20 award; and (d) numbers “5,” “6,” and “31” marked with award indicator 570d and associated with a $50 award.

In various example embodiments, the lottery gaming system randomly associates each lottery number of the set of remaining lottery numbers 550 with a different award according to a paytable (such as paytable 300 of FIG. 3). As such, a player of the lottery game will have greater odds of winning a lower expected payout and have lower odds of winning a higher expected award.

FIG. 5C illustrates an example second set of drawn lottery numbers 580 that are drawn for a play of a lottery game. In this example illustrated embodiment, the second set of drawn lottery numbers 580 includes a selected symbols (or numbers) indicator portion 590 that displays a designated quantity of the second set of drawn lottery numbers 580 for the play of the lottery game. In this illustrated example embodiment, the lottery gaming system randomly determines the second set of drawn lottery numbers 580 after the lottery gaming system determines the set of remaining lottery numbers 550. As such, a lottery number included in the first set of drawn lottery numbers will not be included in the second set of drawn lottery numbers 580. It should be appreciated that while the second set of drawn lottery numbers are displayed with the first set of drawn lottery numbers, the second set of drawn lottery numbers can be displayed separate from the first set of drawn lottery numbers. It should be also appreciated that, the second set of drawn lottery numbers may display or include additional or alternative information, such as a date/time of drawing the first set of drawn lottery numbers, a lottery draw number associated with the first set of drawn lottery numbers, a lottery game number associated with the first set of drawn lottery numbers, and/or any other relevant information. It should also be appreciated that the second set of drawn lottery numbers provided by the lottery gaming system of the present disclosure may be alternatively configured.

In this example illustrated embodiment, the lottery gaming system randomly selects a designated quantity of one lottery number from the remaining set of lottery numbers 550 to form the second set of drawn lottery numbers 580. In other words, in this example illustrated embodiment, the designated quantity of lottery numbers to form the second set of drawn lottery numbers 580 is one lottery number. In the illustrated example embodiment, the lottery gaming system randomly selected the number “43” 590a as the second set of drawn lottery numbers 580 for the play of the lottery game. It should be appreciated that while one lottery number is shown as the designated quantity of lottery numbers that form the second set of drawn lottery numbers, other designated quantities of lottery numbers are possible to form the second set of drawn lottery numbers.

In this example embodiment, after the lottery gaming system randomly selects the second set of drawn lottery numbers 580, the lottery gaming system determines if any purchased lottery tickets match the designated quantity of lottery numbers of the second set of drawn lottery numbers 580. More specifically, the lottery gaming system compares the second set of drawn lottery numbers 580 with the player set of lottery numbers of any lottery tickets purchased for the play of the lottery game. The lottery gaming system then determines whether a designated quantity of lottery numbers of any player set of lottery numbers match the designated quantity of lottery numbers of the second set of drawn lottery numbers 580. In response to determining that a designated quantity of lottery numbers of at least one player set of lottery numbers of a match the designated quantity of the second set of drawn lottery numbers 580, the lottery gaming system is configured provide the player an award associated with that respective lottery number of the player set of lottery numbers (such as upon redemption of the lottery ticket by the player).

In this example illustrated embodiment, number “43” 590a indicated in the indicator portion 590 of the second set of drawn lottery numbers 580 matches number “43” 410e of the player set of lottery numbers. As such, the gaming system determines the award associated with lottery number “43” of the remaining set of lottery numbers 550. In this illustrated example embodiment, the lottery gaming system determines that number “43” of the remaining set of lottery numbers 550 is marked with award indicator 570c and is associated with a $20 award. As such, the gaming system provides the player an award of $20 for the play of the lottery game.

It should be appreciated from the above, that the present disclosure improves lottery gaming technology and current lottery tickets in part by providing a new way for players to interact with the lottery gaming system, and new ways to win awards that are based on the winning outcomes of one or more other players of the lottery game. It should be further appreciated from the above that the present disclosure improves lottery gaming technology in part by associating a purchased lottery ticket with the play of a game in addition to the play of the game. It should further be appreciated from the above that the present disclosure improves lottery gaming technology in part by providing a new type of selection for a player to make for a lottery ticket, and thus also a way to increase lottery ticket sales. It should further be appreciated from the above that the present disclosure improves lottery gaming technology in part by providing new ways to provide different types of awards for lottery tickets, and thus also a way to increase lottery ticket sales. It should further be appreciated from the above that the present disclosure improves lottery gaming technology in part by providing a new way to associate the play of a keno game with the play of a lottery game, and thus also a way to increase lottery ticket sales.

### Example Lottery Gaming Systems—General

As mentioned above, in various embodiments, the lottery gaming system and method of the present disclosure are configured to be operated by a lottery agency (such as a state lottery agency).

As mentioned above, in various other embodiments, the lottery gaming system and method of the present disclosure are configured to be operated by a third party that runs the lottery for a lottery agency (such as a state lottery agency).

FIG. 6 illustrates an example networked lottery gaming system 600 for either such implementation. This example network lottery gaming system 600 generally includes: (1) a plurality of lottery retailer terminals 602-1 to 602-N; (2) a communications network 604; and (3) one or more lottery servers such as lottery server 606. Generally, the retailer terminals 602-1 to 602-N and the lottery server 606 are configured to perform the functions described above and further described below.

In this example embodiment, each retailer terminal 602 corresponds to (or is associated with) a particular lottery retailer. For example, the first retailer terminal 602-1 of FIG. 6 may be associated with a first lottery retailer, such as a convenience store, and the second retailer terminal 602-2 of FIG. 6 may be associated with a second lottery retailer, such as a supermarket. It should be understood that any suitable quantity of lottery retailer terminals may be employed in the lottery gaming system 600, along with any suitable quantity of corresponding lottery servers 606.

In various example embodiments, the lottery retailer terminal 602 includes one or more processor(s). Generally, the processor is operative to perform or process instructions, and in particular, to operate in accordance with the various methods described herein. For example, the processor of the lottery retailer terminal 602 may be operable to enable the lottery retailer terminal 602 to transmit data to (and receive data from) the lottery server 606. More specifically, the processor may enable the transmission of data representing each lottery ticket.

In various example embodiments, the lottery retailer terminal 602 includes one or more input device(s). The input devices of the lottery retailer terminal 602 may include components such as an optical scanner and/or a barcode scanner, for reading and/or for deriving information associated with a playslip and/or a lottery ticket. For example, a lottery ticket may include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various example embodiments, the input device(s) of the lottery retailer terminal 602 may include a clock. The clock may be employed to detect, derive and/or append time and/or date information for use by the lottery server 606 to: (i) create a data record corresponding to lottery tickets purchased at the lottery retailer terminal 602, (ii) to determine redemption time, round and/or date information associated with lottery tickets, and/or (iii) determine whether a lottery player has redeemed their lottery ticket in a manner that qualifies the player to receive a particular redemption or settlement amount.

In various example embodiments, the lottery retailer terminal 602 includes one or more output device(s). Such output device(s) may include such components as a display for outputting information to a lottery player or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various example embodiments, the lottery retailer terminal 602 also includes one or more communications port(s), such as a serial port, a modem or the like. Generally, the communications port of the lottery retailer terminal 602 may be operable to facilitate two-way data communications between (i) the lottery retailer terminal 602, and (ii) the lottery server 606. In accordance with some embodiments, the communications port of the lottery retailer terminal 602 may operate to facilitate the transmission of information between the lottery retailer terminal and a player device such as a personal digital assistant (PDA), cell phone and/or a dedicated (e.g., a proprietary) device.

In various example embodiments, the lottery retailer terminal 602 includes a data storage device such as a hard disk, optical or magnetic media, random access memory (RAM) and/or read-only memory (ROM), or the like memory device. Generally, the data storage device of the lottery retailer terminal 602 stores a software program, the software program enabling a processor of the retailer terminal 602 to perform various functions including some or all of the various steps described herein. For example, as noted above with respect to FIGS. 1 to 5, in accordance with certain embodiments, the lottery retailer terminal 602 may be configured to perform some or all of the functions of the lottery server 606 (and vice versa) such that the lottery server 606 and the lottery retailer terminal 602 may be considered as the same “device.”

In various example embodiments, a lottery sales device may be utilized in place of a lottery retailer terminal 602. Such a lottery sales device may be implemented as a lottery server, a controller, a dedicated hardware circuit, an appropriately programmed general-purpose computer, or any other equivalent electronic, mechanical or electro-mechanical device. Thus, in various embodiments, a lottery sales device may include, for example, but is not limited to: (1) a video lottery terminal that may include a touch sensitive screen for use by a player; (2) a personal computer (e.g., which communicates with a remote lottery server); or (3) a personal mobile device such as a mobile telephone, a tablet, or a personal digital assistant. The lottery sales device may include any or all of the devices of the aforementioned systems.

In this example embodiment, the lottery server 606 operates to: (1) receive and/or store data associated with one or more lottery tickets including such data as: (a) ticket identifier(s), and (b) ticket indicia; (2) determine at least a first redemption amount associated with a lottery ticket; (3) receive a redemption request associated with the lottery ticket; (4) determine a time of play associated with the redemption request; and (5) transmit an indication of the appropriate redemption amount to a lottery retailer terminal (e.g., for output or display to a lottery player and/or lottery terminal operator).

In various example embodiments, the lottery server 606 includes one or more processor(s). Such a processor functions to process instructions, and in particular, to operate in accordance with various methods described herein. For example, the processor may operate to enable the lottery server 606 to transmit data to (and receive data from) the lottery retailer terminal 602. More specifically, the processor of the lottery server 606 may enable the transmission of data representing a lottery ticket, as well as information defining one or more payout(s) associated with that lottery ticket to or by a specific one of the lottery retailer terminals 602 shown in the lottery network 600 of FIG. 6. Thus, the lottery server 606 may be implemented as a system controller, a dedicated hardware circuit, an appropriately and particularly programmed general-purpose computer, or any other equivalent electronic, mechanical or electro-mechanical device capable of providing for one or more of the embodiments described herein.

In various example embodiments, the lottery server 606 includes one or more input device(s). Examples of such input devices include a keypad, a mouse, a touch-screen, a random number generator, a microphone, and other digital or analog input devices.

In various example embodiments, the lottery server 606 also includes one or more output device(s). Example of output device(s) of the lottery server 606 include a monitor or other display for outputting information to an operator of the lottery server 606 (e.g., for displaying information such as statistical or sales data, win and loss information and/or payout amounts), a printer for producing a physical record (e.g., a report) of such data, and the like. In addition, the lottery server 606 may include one or more communications ports, such as a serial port, modem or the like, operable to facilitate two-way data communications between (i) the lottery server 606 and (ii) one or more lottery retailer terminals 602.

In various example embodiments, the lottery server 606 includes a data storage device (e.g., a hard disk or hard drive, a media-based (removable) memory, or the like). In certain embodiments, the data storage device of the lottery server 606 stores at least one software program, which includes a program to enable the processor of the lottery server 606 to perform some or all of the various steps and functions of at least one implementation of the methods described in detail herein. In addition, the data storage device of the lottery server 606 may operate to store one or more databases including a lottery ticket database and a lottery ticket redemption status database.

In various example embodiments, the lottery server 606 includes a lottery ticket server device that is located at a lottery ticket printing facility, and may also function to manage the ticket printing process. The lottery server 606 may also function to develop a lottery game matrix (e.g., determining base payouts, win frequencies, and the like) and to match static lottery content with secure paytable (or payout distribution) data. In certain embodiments, a lottery ticket printer device for use in such lottery gaming systems may utilize the game matrix information from the lottery server and may apply it to the secure paytable data.

In certain example embodiments, a retailer terminal (such as the first retailer terminal 602-1) of FIG. 6 is configured to perform some or all of the functions of the lottery server 606. Thus, in certain example embodiments, the lottery server 606 and the retailer terminal (such as the first retailer terminal 602-1) (or another given retailer terminal and server pairing) may be considered as the same “device.”

Generally, the communications network 604 of FIG. 6 includes one or more local and/or wide-area network(s) proprietary and/or public network(s) (e.g., the Internet) for facilitating two-way data communications between the retailer terminals 602 and the lottery server 606. The lottery server 606 may communicate with lottery retailer terminals 602 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any number and type of devices may be in communication with the lottery server 606, and communication between the lottery retailer terminals 602 and the lottery server 606 may be direct or indirect. A variety of communications protocols may be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and may actually refrain from exchanging data most of the time. For example, a device in communication with another device via the Internet may not transmit data to the other device for days or weeks at a time. In some embodiments, a server may not be necessary and/or preferred. For example, in one or more embodiments, methods described herein may be practiced on a stand-alone gaming device and/or a gaming device in communication only with one or more other gaming devices. In such an embodiment, any functions described as performed by the computer may instead be performed by one or more gaming devices.

As used herein, a lottery retailer may include a merchant who sells lottery tickets at a particular location, authenticates winning lottery tickets, redeems authenticated winning lottery tickets, and/or provides awards to players for winning lottery tickets. Examples of various lottery retailers include, but are not limited to, convenience stores, gas stations, supermarkets, and gaming establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery gaming system comprising:
a processor; and
a memory device that stores a plurality of instructions, that when executed by the processor, cause the processor to:
for a play of a lottery game:
determine a player set of symbols from a set of symbols, the set of symbols comprising a plurality of different symbols;
generate a lottery ticket comprising an indication of the player set of symbols;
store data associated with the lottery ticket;
cause the lottery ticket to be provided to the player;
randomly select a first set of draw symbols from the set of symbols;
determine, based on the first set of draw symbols, a set of remaining symbols of the set of symbols, wherein the set of remaining symbols comprises the symbols of the set of symbols minus the symbols of first set of draw symbols;
associate a set of awards with the set of remaining symbols;
randomly select a second set of draw symbols from the set of remaining symbols; and
determine any of the awards associated with the player set of symbols based on a comparison of the player set of symbols and the second set of draw symbols, and based on the awards associated with the set of remaining symbols.

2. The lottery gaming system of claim 1, wherein the set of awards comprises a plurality of different awards, and the instructions, when executed by the processor, cause the processor to associate the plurality of different awards with the symbols of the set remaining symbols such that each symbol of the set of symbols is associated with one of the different awards.

3. The lottery gaming system of claim 1, wherein the second set of draw symbols comprises one symbol from the set of remaining symbols.

4. The lottery gaming system of claim 3, wherein the comparison of the player set of symbols and the second set of draw symbols comprises a determination of whether the player set of symbols comprises the one symbol of the second set of draw symbols.

5. The lottery gaming system of claim 1, wherein the comparison of the player set of symbols and the second set of draw symbols comprises a determination of whether the player set of symbols comprises a designated quantity of the symbols of the second set of draw symbols.

6. The lottery gaming system of claim 1, wherein the plurality of different symbols of the set of symbols are keno game symbols and the random selection of the first set of draw symbols from the set of symbols is part of a play of a keno game that is in addition to the lottery game.

7. The lottery gaming system of claim 6, wherein the player set of symbols is associated with the play of the keno game.

8. The lottery gaming system of claim 1, wherein the player set of symbols is player selected from the set of symbols.

9. The lottery gaming system of claim 1, wherein the plurality of instructions, when executed by the processor, cause the processor to communicate data to cause a display device to display the remaining symbols from the set of symbols, and indications of the awards associated with the remaining symbols.

10. A gaming system comprising:
a processor; and
a memory device that stores a plurality of instructions, that when executed by the processor, cause the processor to:
for a play of a game:
determine a player set of symbols from a set of symbols the set of symbols comprising a plurality of different symbols;
at a first draw time, randomly select a first quantity of draw symbols from the set of symbols;
determine a plurality of remaining symbols from the set of symbols that are not any of the first quantity of draw symbols;
associate a plurality of different awards with the determined plurality of remaining symbols, such that each remaining symbol is associated with one of the plurality of different awards;
communicate data to cause a display, by a display device, of the determined plurality of remaining symbols from the set of symbols, and indications of each of the awards associated with the determined plurality of remaining symbols;
at a second draw time, randomly select one of the determined plurality of remaining symbols from the set of symbols; and
responsive to the randomly selected one of the determined plurality of remaining symbols being one of the player set of symbols, determine the award randomly associated with the selected one of the remaining symbols.

11. The gaming system of claim 10, wherein the plurality of different symbols of the set of symbols are keno game symbols and the random selection of the first set of draw symbols from the set of symbols is part of a play of a keno game in addition to the game.

12. The gaming system of claim 11, wherein the player set of symbols are for the play of the keno game.

13. A method of operating a lottery gaming system, said method comprising:
for a play of a lottery game:
determining, via a processor, a player set of symbols from a set of symbols, the set of symbols comprising a plurality of different symbols;
generating, via the processor, a lottery ticket comprising an indication of the player set of symbols;
storing, via the processor and a memory device, data associated with the lottery ticket;
causing, via the processor, the lottery ticket to be provided to the player;
randomly selecting, via the processor, a first set of draw symbols from the set of symbols;
determining, via the processor, based on the first set of draw symbols, a set of remaining symbols of the set of symbols, wherein the set of remaining symbols comprises the symbols of the set of symbols minus the symbols of first set of draw symbols;
associating, via the processor, a set of awards with the set of remaining symbols;
randomly selecting, via the processor, a second set of draw symbols from the set of remaining symbols; and
determining, via the processor, any of the awards associated with the player set of symbols based on a comparison of the player set of symbols and the second set of draw symbols, and based on the awards associated with the set of remaining symbols.

14. The method of claim 13, wherein the set of awards comprises a plurality of different awards, and which comprises associating, via the processor, the plurality of different awards with the symbols of the set remaining symbols such that each symbol of the set of symbols is associated with one of the different awards.

15. The method of claim 13, wherein the second set of draw symbols comprises one symbol from the set of remaining symbols.

16. The method claim 15, wherein the comparison of the player set of symbols and the second set of draw symbols comprises determining, via the processor, whether the player set of symbols comprises the one symbol of the second set of draw symbols.

17. The method of claim 13, wherein the comparison of the player set of symbols and the second set of draw symbols comprises determining, via the processor, whether the player set of symbols comprises a designated quantity of the symbols of the second set of draw symbols.

18. The method of claim 12, wherein the plurality of different symbols of the set of symbols are keno game symbols and the random selection of the first set of draw symbols from the set of symbols is part of a play of a keno game that is in addition to the lottery game.

19. The method of claim 18, wherein the player set of symbols is associated with the play of the keno game.

20. The method of claim 13, which comprises communicating data to cause a display device to display the remaining symbols from the set of symbols, and indications of the awards associated with the remaining symbols.
